(19) United States
(12) Patent Application Publication
(10) Pub. No.: US 2024/0215597 A1
(43) Pub. Date: Jul. 4, 2024

(54) NON-DAIRY CHEESE ANALOGUE

(71) Applicant: Oatly AB, Malmö (SE)

(72) Inventors: Stina Burri, Malmö (SE); Matilda Ulmius Storm, Malmö (SE); Yoga Putranda, Malmö (SE); Ida Andersson, Malmö (SE); Karin Petersson, Malmö (SE); Sofia Ehlde, Malmö (SE)

(21) Appl. No.: 18/558,084

(22) PCT Filed: Apr. 30, 2021
(86) PCT No.: PCT/EP2021/061446

§ 371 Date: Oct. 30, 2023

(51) Int. Cl. A23C 20/02; A23J 3/14; A23L 7/104

(52) U.S. Cl. CPC A23C 20/025; A23J 3/14; A23L 7/104

(57) ABSTRACT

A non-dairy cheese analogue has an oat derived material in an amount of 3-15% by weight of the cheese analogue, at least one vegetable fat present in an amount of 10-25% by weight of the cheese analogue, and at least one vegetable protein present in an amount of 10-25% by weight of the cheese analogue.

### TECHNICAL FIELD OF THE INVENTION

The present invention relates to non-dairy cheese analogues and to methods for preparing the same.

### BACKGROUND

Cheese analogues, also known as, for example, cheese alternatives, are products used as replacements or as alternatives for traditional dairy cheese. Such analogues may contain both dairy and non-dairy components depending on the intended use and consumer of the final product. There is a growing population which refrain from consumption of dairy products as well from meat products, for example for health reasons, religious reasons, and sustainability reasons. There is a growing trend, to choose products for consumption in the daily life which contribute to a positive climate impact. This may mean excluding or at least reducing intake of dairy based products as well as meat products. The population consuming only vegetables, vegetarians, and vegans, is growing and the interest for such products is expected to grow.

Feta is a white cheese originally from Greece. It is made from sheep's milk or from a mixture of sheep and goat's milk or cow's milk. It is usually prepared and formed into larger white blocks and aged in brine. Feta is often used as component in sallads such as Greek sallads and is also included in other Greek dishes. Halloumi is a semi-hard, unripened cheese made from a mixture of goat's and sheep's milk, and sometimes also cow's milk. It is a very popular cheese throughout the Eastern Mediterranean and is often associated with Cyprus. However, the popularity of the cheese has grown over the European continent as well as globally. It has a high melting point and therefore can easily be fried or grilled.

There are non-dairy cheese analogues available on the market, but there is a need and demand for cheese analogues having an improved desirable texture and taste to suit the consumer. In addition, many prior art cheese analogues are starch-based which may not, for some consumers, be preferred in view of nutrient content. There is a growing demand for protein-based cheese analogues. Prior art non-dairy cheese analogues may suffer from having floury or sandy mouthfeel. It is also known that quite many prior art non-dairy cheese analogues have an artificial taste. With higher requirements on taste and texture there is a continued need for new products, which are appealable to the growing consumer population, as well as providing positive health effects, and being sustainable from an environmental perspective. It is a further need to allow provision of cheese analogues suitable for preparation and cooking and/or frying.

### SUMMARY OF THE INVENTION

In light of the above, it is an object of the present inventive concept to provide a non-dairy cheese analogue such as non-dairy alternatives to cheeses, such as to well-known feta and halloumi cheeses, wherein above-mentioned disadvantages of the prior art are addressed.

According to a first aspect of the present inventive concept there is provided a non-dairy cheese analogue such as a non-dairy cheese analogue with an oat content. The non-dairy cheese analogue comprises: an oat derived material in an amount of 3-15% by weight of the cheese analogue; at least one vegetable fat present in an amount of 10-25% by weight of the cheese analogue; and at least one vegetable protein present in an amount of 10-25% by weight of the cheese analogue.

It has been shown according to the present disclosure that improved cheese analogues have been provided with both improved texture, such as improved creaminess, and taste.

According to a second aspect of the present inventive concept, there is provided a method for manufacturing of a vegetable cheese analogue, the method comprising: providing a mixture comprising oat derived material, at least one vegetable fat, and at least one vegetable protein; adding fermenting culture; and, optionally, adding transglutaminase to the mixture; fermenting the mixture, under formation of curd.

According to a third aspect of the present inventive concept, there is provided a non-dairy cheese analogue obtainable by the method according to the second inventive concept.

Features from the first aspect may be relevant also for the second or third aspects, and vice versa.

### BRIEF DESCRIPTION OF THE DRAWINGS

Aspects of the present disclosure will now be described in more detail, with reference to the appended drawings showing embodiments and examples, in which:

FIG. 1 discloses a picture of a non-dairy cheese analogue prepared through a non-pressing method. FIG. 1a discloses the non-dairy cheese analogue (halloumi resembling) as obtained after the manufacturing steps. FIG. 1b discloses the same non-dairy cheese analogue (halloumi resembling) which has been fried and forming a browning surface.

FIG. 2 discloses a picture of a non-dairy cheese analogue prepared through a pressing method. FIG. 2a discloses to the left the non-dairy cheese analogue (halloumi resembling) as obtained after manufacture (including pressing) and to the right the same cheese analogue as obtained after frying in a pan. FIG. 2b discloses a non-dairy cheese analogue (feta resembling) as obtained after the manufacturing steps.

FIG. 3 discloses a picture of two examples of non-dairy cheese analogues resembling halloumi prepared through a pressing method. To the left a non-dairy cheese analogue has been prepared with the addition of deamidated oat-derived material and to the right a non-dairy cheese analogue has been prepared with the addition of water instead of oat-derived material. In the lower part of the picture the two non-dairy cheese analogues have been fried in a pan. It is clear that the cheese analogue to the left prepared with oat-derived material shows a nice browning of the surface of the cheese analogue. The cheese analogue to the right prepared with only water does not disclose a desirable browning of the surface after frying.

### DETAILED DESCRIPTION

The present invention will now be described more fully hereinafter. This invention may, however, be embodied in many different forms and should not be construed as limited to the embodiments set forth herein; rather, these embodiments are provided for thoroughness and completeness, and to fully convey the scope of the invention to a skilled person. Although individual features may be included in different embodiments, these may possibly be combined in other ways, and the inclusion in different embodiments does not imply that a combination of features is not feasible. In addition, singular references do not exclude a plurality. In the context of the present invention, the terms “a”, “an” does not preclude a plurality.

The present inventive concepts are, at least in part, based on unexpected realizations that non-dairy cheese analogues with desirable properties, including e.g. having improved texture and better taste, may be provided having a content of oat derived material and further ingredients comprising vegetable protein, and fat.

In addition, it has been shown that certain cheese analogues resembling halloumi cheeses have a nice browning of the surface once fried.

According to a first aspect of the present inventive concept there is provided a non-dairy cheese analogue comprising: an oat derived material in an amount of 3-15% by weight of the cheese analogue; at least one vegetable fat present in an amount of 10-25% by weight of the cheese analogue; and at least one vegetable protein present in an amount of 10-25% by weight of the cheese analogue.

The oat derived material in an amount of 3-15% by weight of the cheese analogue is herein referred to as an oat derived material comprising dry matter in an amount of 3-15% by weight of the cheese analogue. It has been shown according to the present disclosure that improved cheese analogues with the combination of components as described above have been provided with both improved texture such as improved creaminess and taste such as reduced or fully omitted artificial taste.

The oat derived material may, for example, be provided in dry form during manufacturing of the non-dairy cheese analogue. Further, the oat derived material may be provided in liquid form, e.g. an aqueous oat derived material during manufacturing of the non-dairy cheese analogue. Thus, the oat derived material may be provided as a liquid oat derived material. The oat derived material may be provided as an oat drink, for example a liquid product sometimes referred to as an oat milk. For the purpose of improving understanding, the non-dairy cheese analogue may be obtained using a liquid or aqueous oat derived material, such as a liquid oat base, comprising, for example, 1-20% by weight of dry matter, such as 5-15% by weight, e.g. 10-15%, such as 13 or 14%.

Furthermore, said oat derived material may comprise 5-20%, by dry weight, protein, e.g. 5-15, 6-14%, 7-13%, 6-12%, by dry weight protein, and 3-10%, by dry weight, fat, e.g. 4-9%, 5-8%, by dry weight, fat. The oat derived material may also comprise carbohydrates and/or starch.

The oat derived material, may, thus, provide the non-dairy cheese analogue with oat protein and fat in addition to the at least one vegetable protein and the at least one vegetable fat comprised by the non-dairy cheese analogue. The at least one vegetable protein and the at least one vegetable fat of the non-dairy cheese analogue, may, thus, be in addition to any fat and protein of the oat derived material.

The oat derived material may provide for example flavor, color, texture, browning and structure to the non-dairy cheese analogue, as well as, for example, providing a source of proteins, vegetable fat and fibers. For example, the oat derived material may provide ß-glucans to non-dairy cheese analogue, which in combination with other ingredients of the non-dairy cheese analogue may provide health-beneficial properties, which may include assisting in lowering cholesterol levels and blood sugar levels.

The oat derived material, e.g. as described herein above, may be described as obtained from treatment of oats with suitable enzymes for degradation or breakdown of starch present in the oats, such as amylase. For example, α- and/or β-amylase may be used. Thereby, the oat derived material may comprise one, more or all of monosaccharides, disaccharides, for example, maltose, oligosaccharides, and/or fiber, for example β-glucans. The oat derived material may further comprise proteins and fat from the oats. All or part of unreacted or partly reacted starch and fibers from the oats may be removed or reduced in content in the treatment of the oats or prior to the addition of the oat-base to the non-dairy cheese analogue.

There is provided in an embodiment of the invention, a non-dairy cheese analogue comprising: an oat derived material in an amount of 5-12% by weight of the cheese analogue; at least one vegetable fat present in an amount of 17-25% by weight of the cheese analogue; and at least one vegetable protein present in an amount of 10-17% by weight of the cheese analogue. As an alternative to the oat derived material being present in an amount of 5-12% by weight of the cheese analogue, the oat derived material may be present in an amount of 6-15%, or 3-7%.

The non-dairy cheese analogue may further comprise calcium, for example in form of tri-calcium phosphate or any other suitable calcium salts. The calcium may also be present in mono- and dicalcium phosphate or any other form. The amount of calcium present in the non-dairy cheese analogue may be in an amount of 0.05 to 0.6% by weight of the cheese analogue, such as 0.10-0.6%, e.g. 0.2 to 0.5%, 0.3-0.4% by weight of the non-dairy cheese analogue. The non-dairy cheese analogue may further comprise salt such as sodium chloride.

The non-dairy cheese analogue as disclosed herein may be a fermented non-dairy cheese analogue. A mixture comprising the oat derived material, the vegetable fat, and the at least one vegetable protein may be fermented during manufacturing of the non-dairy cheese analogue, thereby providing a fermented non-dairy cheese analogue. A starter culture (strain) is added during the manufacture of the non-dairy cheese to provide the fermentation. Exemplary commercially available starter strains may be one or more of the following Streptococcus thermophilus, Lactobacillus acidophilus and Bifidobacterium animalis spp. Lactis, Lactobacillus acidophilus, Lactobacillus paracasei och Pedicoccus pentosacceus. Any other suitable commercially available starter strain may also be used. The added starter culture ferments the sugar present in the mixture comprising the oat derived material, the vegetable fat, and the at least one vegetable protein. Sugar may be added initially during the manufacture of the non-dairy cheese analogue, but in the final product, all or a majority of the sugar has been fermented by the added starter culture. For example, sucrose may be added before or during fermentation.

In an embodiment of the invention there is a provided a feta-resembling non-dairy cheese analogue, comprising an oat derived material in an amount of 5-12% by weight of the cheese analogue; at least one vegetable fat present in an amount of 17-25% by weight of the cheese analogue; at least one vegetable protein present in an amount of 10-17% by weight of the cheese analogue; and wherein the non-dairy cheese analogue is fermented and comprises calcium.

The obtained feta-resembling non-dairy cheese analogue have been shown to have improved texture and better taste compared to prior art non-dairy cheeses.

In a further embodiment, there is a provided a feta-resembling non-dairy cheese analogue, comprising an oat derived material in an amount of 5-12% by weight of the cheese analogue; at least one vegetable fat present in an amount of 18-23% by weight of the cheese analogue; at least one vegetable protein present in an amount of 12-17% by weight of the cheese analogue; and wherein the non-dairy cheese analogue is fermented and comprises calcium.

The prepared feta-resembling non-dairy cheeses may be manufactured both through techniques involving dewatering of the curd, e.g. through pressing, or non-dewatering, or non-pressing, techniques. Dewatering as used herein results in increasing of dry matter of the non-dairy cheese analogue during the dewatering. Non-pressing technique according to embodiments herein may involve a higher concentration of dry matter of the curd, as compared to dewatering techniques, which non-pressing may provide non-dairy cheese analogues with dry matter concentrations as high as non-dairy cheese analogues obtained from pressing. With non-pressing techniques, the manufacturing of the non-dairy cheese analogue may be more efficiently realized and under improved hygienic conditions. For example, a higher dry matter concentration of the curd may typically involve lower volumetric process flows and smaller equipment. With non-pressing techniques, as compared to dewatering techniques, leaking or undesired removal of desired compounds from the curd may be reduced. On the other hand, dewatering, such as through pressing, may be efficient means for concentration of dry matter of the non-dairy cheese analogue, and may be used to control amounts of solubilized compounds in the final non-dairy cheese analogue. Yet further, dewatering, such as pressing, may result in desirable structure and shape of the non-dairy cheese analogue. For example, dewatering may be realized thorough pressing using e.g. filter material, such as cloth, mould, membrane or a sieve. Further, techniques using or being based on osmosis may be used.

In an embodiment of the invention there is a provided a halloumi-resembling non-dairy cheese analogue, comprising an oat derived material in an amount of 5-12% by weight of the cheese analogue; at least one vegetable fat present in an amount of 17-25% by weight of the cheese analogue; at least one vegetable protein present in an amount of 10-17% by weight of the cheese analogue; wherein the non-dairy cheese analogue is fermented, comprises calcium and wherein glutamine and lysine units of the at least one vegetable protein have been cross-linked by means of transglutaminase.

It has been shown in the experimental part of the present disclosure that certain cheese analogues resembling halloumi cheeses obtain a nice browning of the surface during frying. Browning is a desirable feature for halloumi-like non-dairy cheese analogues since this is a feature of the original dairy halloumi cheeses available. In addition, a nice taste and texture has also been provided.

In a further embodiment of the invention there is a provided a halloumi-resembling non-dairy cheese analogue, comprising an oat derived material in an amount of 5-12% by weight of the cheese analogue; at least one vegetable fat present in an amount of 18-23% by weight of the cheese analogue; at least one vegetable protein present in an amount of 13-17% by weight of the cheese analogue; wherein the non-dairy cheese analogue is fermented, comprises calcium and wherein glutamine and lysine units of the at least one vegetable protein have been cross-linked by means of transglutaminase.

The prepared halloumi-resembling non-dairy cheeses may be manufactured through both techniques involving dewatering of the curd, eg. through pressing, and non-dewatering, or non-pressing, techniques.

The oat derived material as used in the non-dairy cheese analogue may be a deamidated oat derived material or a non-deamidated oat derived material.

In an embodiment of the invention transglutaminase is added during the manufacturing of the non-dairy cheese analogue, thereby glutamine and lysine units of the at least one vegetable protein as present in the non-dairy cheese analogue are cross-linked by means of transglutaminase. This provides a chewy texture of the non-dairy cheese analogue. This is particularly desirable during manufacturing of halloumi-resembling non-dairy cheese analogue.

A preferred amount of added transglutaminase is from 0.1 U/g to 1 U/g cheese analogue, in particular from 0.2 U/g to 0.8 U/g cheese analogue, for example about 0.3, 0.4, 0.5, or 0.6 U/g cheese analogue. The amount of added transglutaminase is dependent on the amount of vegetable protein used in the preparation of the cheese analogue.

The non-dairy cheese analogue may comprise water, wherein water is present in the non-dairy cheese analogue in an amount of 40 to 70% by weight of the cheese analogue such as 45 to 65% by weight of the cheese analogue for instance 50 to 60%, e.g. 51-59%, e.g. 52-58%, e.g. 53-57, e.g. 54-56% or 55% by weight of the cheese analogue.

The non-dairy cheese analogue may, in addition to any oat protein present in the oat derived material, comprise at least one vegetable protein, wherein the at least one vegetable protein is selected from a list consisting of pea protein, potato protein, faba bean protein, chickpea protein, lentil protein, mung bean, and combinations thereof, preferably the at least one vegetable protein is pea protein alone or in combination with any of the mentioned proteins; and wherein, optionally, the cheese analogue further comprises one or more additives selected from the group consisting of hydrocolloids and/or texturizers, including carrageenans, agars, pectins, gellan gum, locust bean gum, methyl cellulose and xanthan.

The at least one vegetable protein may independently be provided in form of a protein isolate or a protein concentrate. Protein isolate or protein concentrate may contain other components than the vegetable protein. For example the vegetable protein may be a protein isolate having a protein content of at least 80%, or a protein concentrate having a protein content of at least 50%. In particular, protein isolate having a protein content of at least 80%, or a protein concentrate having a protein content of at least 50% may be used in the method of manufacturing the cheese analogue.

Thereby, it shall be realised that although it is possible to use highly concentrated protein fractions, such as having protein content of above 95%, or even 100%, it is efficient to use protein fractions having lower concentrations of protein, such as above 50%. Protein fractions having such lower concentrations of protein may be more readily available, and less processed.

The proteins, protein isolates or protein concentrates may be processed during manufacturing of the same for example by heating, enzymatic treatment or any other process that will lead to a final, functional protein, protein isolate, protein or concentrate having desirable properties.

The non-dairy cheese analogue comprises at least one vegetable fat which may be a combination of vegetable fats, wherein the at least one vegetable fat may comprise 45-75% of saturated fat, e.g. 45-65%, e.g. 50-60%, such as 52-58%, 54-56%, for example 55 or 56%, by weight saturated fat, 20-34% of monounsaturated fat, e.g. 24-30% by weight, such as 26-28%, for example 26 or 27%, by weight monosaturated fat, and 5-19% of polyunsaturated fat, such as 7-17%, e.g. 10-14%, e.g. 11-13%, for example 12 or 13%, by weight of polyunsaturated fat, by weight of the vegetable fat. Thus, the vegetable fat added in liquid form or solid form may comprise a mixture of saturated fat, monounsaturated fat and polyunsaturated fat. The vegetable fat may be a vegetable fat or oil and should preferably generally be acceptable to the vegetarian and vegan consumer. The vegetable fat may for example be selected from a rapeseed oil, sunflower oil, coconut oil, or corn oil or a combination thereof. For example, a combination of coconut oil and rapeseed oil may be used, which for example comprises saturated fat in an amount of 65-75% by weight of the vegetable fat

According to a second aspect of the present invention there is provided a method for manufacturing of non-dairy cheese analogue, wherein the method comprising: providing a mixture comprising oat derived material, at least one vegetable fat, and at least one vegetable protein; adding fermenting culture; and, optionally, adding transglutaminase to the mixture; and fermenting the mixture, under formation of curd. Prior to the adding fermenting culture, the mixture may further be subjected to heat treatment to above 38ºC, followed by cooling of the mixture to below 38ºC.

During the method for manufacturing of the non-dairy cheese analogue, prior to the adding fermenting culture, the mixture may be subjected to heat treatment to above 38° C., for instance to a temperature between 50 and 150° C., such as from 50 to 100° C., e.g. 70-100, such as between 85 and 95° C., for a period of 1 to 100 seconds, such as 1 to 30 seconds and or followed by cooling the mixture to below 38° C. The oat derived material may be subjected to UHT (ultra-high temperature) treatment prior to addition to the cheese analogue. Alternatively, the UHT treatment may be conducted at the start or during the manufacturing of the cheese analogue or the finally obtained cheese analogue may be subjected to UHT treatment.

In one embodiment, during the method for manufacturing of the non-dairy cheese analogue, the providing a mixture comprises;
mixing the oat derived material and water, thereby obtaining a mixture,
adding dry ingredients comprising vegetable protein under heating between 50° C. and 70° C., and thereafter the vegetable fat in liquid form,
homogenisation, thereby providing the mixture comprising oat derived material, vegetable fat, and at least one vegetable protein.

During the method for manufacturing of a non-dairy cheese analogue, the obtained curd may be subjected to treatment for removal of water, optionally followed by soaking the obtained curd in brine. The removal of water may take place through pressing techniques, for example using filters or cloth and mould. Pressing techniques of cheeses are known methods for manufacture of cheeses. In the present disclosure, both pressing and non-pressing techniques may be used. Pressing techniques lead to removal of an amount of water, or aqueous liquid, leading to a final product with lower water content. In case of using a non-water removal technique or a non-pressing method the amount of added water initially present may be lower compared to using a pressing technique. For example, when a liquid oat base is used in the manufacturing, less volume may be used as compared to if dewatering or pressing is used.

In another embodiment, during the method for manufacturing of non-dairy cheese analogue the providing a mixture comprises;
mixing the oat derived material and water, thereby obtaining a mixture,
heating the mixture to a temperature between 50° C. and 90° C.,
adding dry ingredients comprising vegetable protein under continued heating between 50° C. and 90° ° C., and thereafter adding the vegetable fat in liquid form,
followed by emulsification, thereby providing the mixture comprising oat derived material, vegetable fat, and at least one vegetable protein.

During the method for manufacturing of a non-dairy cheese analogue a transglutaminase may be added in order to provide for certain properties, including a certain texture and hardness. The transglutaminase may be added before, during, and/or after the fermentation. Transglutaminases includes enzymes that catalyze the formation of a bond between glutamine residue side chains and lysine residue side chains, thereby allowing cross-linking between aminoacids and between proteins. The transglutaminase may be inactivated as the non-dairy cheese analogue has reached desired texture and taste. In particular for non-dairy cheese analogues resembling halloumi cheese transglutaminase may be used.

In the method for manufacturing of the non-dairy cheese analogue, the amount of the oat-derived material may be 3-15%, for example 5-10%, by weight of the mixture, the amount of the at least one vegetable protein may be 5-25%, for example 10-20%, by weight of the mixture, and the amount at the least one vegetable fat may be 5-25%, for example 10-20%, by weight of the mixture. The amount of the oat-derived material, at least one vegetable protein and at least one fat as used in the method for manufacturing of the cheese analogue depends on whether a pressing or non-pressing method used. The other components as used may be around 1-3% by weight sugar such as sucrose of the mixture, 30-70% water and 0.2-0.4% by weight calcium of the mixture.

According to a third aspect of the present invention there is provided a method as described above for manufacturing of the non-dairy cheese analogue such as non-dairy cheese analogue resembling feta and/or non-dairy cheese analogue resembling halloumi.

According to an additional aspect there is provided a non-dairy cheese analogue obtainable by the method as described above.

The oat derived material may be obtained from treatment of oats comprising treatment with an enzyme such as amylase, for example as has been described in patent No. EP 1 383 396 B1.

Different non-dairy cheese analogues as have been prepared will now be described.

### EXAMPLES

### Example 1a—Preparation of a Non-Dairy Cheese Analogue Resembling Feta without Dewatering or Pressing Technique

A deamidated oat base (426 g) was mixed with water (340 g) in a thermomixer at 75° C. Dry ingredients including protein (80 g pea protein isolate and 80 g mung bean protein isolate), calcium (3.7 g tricalcium phosphate) and sugar (20 g sucrose) was added to the oat base mixture and heated to 75° C. Liquid fat (200 g mixture of rapeseed oil and coconut oil) was added to the mixture at 75° C. and the mixture was subjected to emulsification in the thermomixer. Thereafter the mixture was homogenized at 150/30 bar at 60-75° C. and the mixture was heated for example to 100° C. Thereafter, the mixture was cooled to 38° C. and starter culture (Lactobacillus acidophilus NCFM, Lactobacillus paracasei och Pedicoccus pentosacceus) was added. The mixture was fermented overnight at 38° C. Thereafter, the prepared cheese was put in brine at pH 4.5. The non-dairy cheese was packed and kept refrigerated.

The obtained non-dairy cheese analogue, resembling feta, was described as having a nice creamy and salt taste and a crumbly texture.

### Example 1b—Preparation of a Non-Dairy Cheese Analogue Resembling Halloumi without Dewatering or Pressing Technique

A deamidated oat base (426 g) was mixed with water (340 g) in a thermomixer at 75° C. Dry ingredients including protein (80 g pea protein isolate and 80 g mung bean protein isolate), calcium (3.7 g tricalcium phosphate) and sugar (20 g sucrose) was added to the oat base mixture, mixed and heated to 75° C. Melted fat (200 g mixture of rapeseed oil and coconut oil) was added to the mixture at 75° C. and the mixture was subjected to emulsification in the thermomixer. Thereafter, the mixture was homogenized at 150/30 bar and the mixture was heated for example to 100° C. Thereafter, the mixture was cooled to 38° C. and transglutaminase was added to the mixture. Starter culture (Streptococcus thermophilus, Lactobacillus acidophilus and Bifidobacterium animalis spp. Lactis) was added. The mixture was fermented overnight at 38° C. Thereafter, the prepared cheese was put in hot brine at 85° C., at pH 4.5. The non-dairy cheese was packed and kept refrigerated.

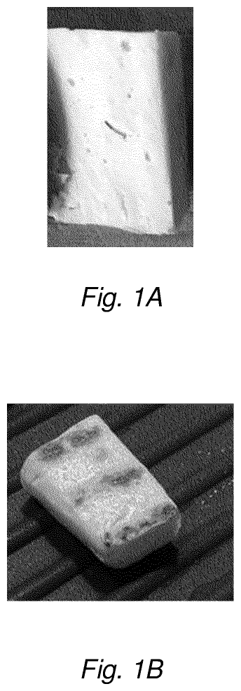

The obtained non-dairy cheese analogue, resembling halloumi, was described as having a nice chewiness and taste including good salt and acidity level. The texture was similar to halloumi. The halloumi was fried in a pan, whereby a nice browning of the surface was observed. See FIG. 1a, before frying, and 1b, once fried.

TABLE 1
Components of obtained non-dairy cheese analogues without pressing
technique.

| | Protein (%) | Fat (%) | Oat (%) |
|---|---|---|---|
| Ex. | 13.1 | 19.2 | 5.6 |
| Feta | | | |
| Ex. | 13.1 | 19.1 | 5.5 |
| Halloumi | | | |

### Example 2a—Preparation of a Non-Dairy Cheese Analogue Resembling Feta with Pressing Technique

A deamidated oat base (426 g) was mixed with water (340 g) in a thermomixer at 75° C. Dry ingredients including protein (100 g pea protein isolate), calcium (3.7 g tricalcium phosphate) and sugar (20 g sucrose) were added to the oat base mixture and heated to 75° C. Liquid fat (111 g mixture of rapeseed oil and coconut oil) was added to the mixture at 75° C. and the mixture was subjected to emulsification in the thermomixer. Thereafter the mixture was homogenized at 150/30 bar at 65-70° C. and the mixture was sterilized for example by heating to 100° C. Thereafter, the mixture was cooled to 38° C. and starter culture (Lactobacillus acidophilus NCFM, Lactobacillus paracasei och Pedicoccus pentosacceus) was added. The mixture was fermented overnight at 38° C. Thereafter, the prepared curd was cut into small pieces and put into moulds with cloths. The moulds were subjected to pressing for 5 h at room temperature. The cheese was put in brine at pH 4.5. The non-dairy cheese was packed and kept refrigerated.

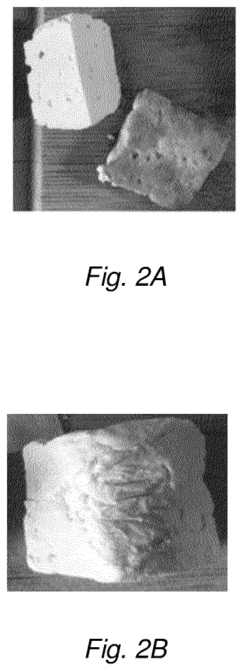

The obtained non-dairy cheese analogue, resembling feta, was described as having a very nice taste including a nice acidity and crumbly texture. See FIG. 2b.

### Example 2b—Preparation of a Non-Dairy Cheese Analogue Resembling Halloumi with Pressing Technique

A deamidated oat base (426 g) was mixed with water (340 g) in a thermomixer at 75° C. Dry ingredients including protein (100 g pea protein isolate), calcium (3.7 g tricalcium phosphate) and sugar (20 g sucrose) were added to the oat base mixture and heated to 75° C. Liquid fat (111 g mixture of rapeseed oil and coconut oil) was added to the mixture at 75° C. and the mixture was subjected to emulsification in the thermomixer. Thereafter the mixture was homogenized at 150/30 bar at 65-70° C. and the mixture was heated for example to 100° C. Thereafter, the mixture was cooled to 38° C. and transglutaminase was added to the mixture. Starter culture (Streptococcus thermophilus, Lactobacillus acidophilus and Bifidobacterium animalis spp. Lactis) was added. The mixture was fermented overnight at 38° C. Thereafter, the prepared curd was cut into small pieces and put into moulds with cloths. The moulds were subjected to pressing for 5 h at room temperature. The cheese was put in brine at pH 4.5. The non-dairy cheese was packed and kept refrigerated.

The obtained non-dairy cheese analogue, resembling halloumi, was described as having a nice taste including a nice salt taste and acidity. The texture was firm. Once fried, nice browning was obtained. See FIG. 2a.

TABLE 2
Components of obtained non-dairy cheese analogues with pressing
technique

| | Protein (%) | Fat (%) | Oat (%) |
|---|---|---|---|
| Ex. | 13.4 | 18.5 | 9.6 |
| Feta | | | |
| Ex. | 16.3 | 22.5 | 11.6 |
| Halloumi | | | |

Although experiments discussed above were conducted using deamidated oat base, i.e. what may be used for manufacturing of an oat drink, sometimes referred to as an oat milk, which was readily available for the experiments, it shall be appreciated that further experiments have been conducted with similar but non-deamidated oat-bases with comparable and similar results.

### Example 3a—Preparation of a Halloumi Resembling Non-Dairy Cheese Analogue Prepared with Oat-Base

A deamidated oat base (426 g) was mixed with water (340 g) in a thermomixer at 75° C. Dry ingredients including protein (100 g pea protein isolate), calcium (3.7 g tricalcium phosphate) and sugar (20 g sucrose) were added to the oat base mixture and heated to 75° C. Liquid fat (111 g mixture of rapeseed oil and coconut oil) was added to the mixture at 75° C. and the mixture was subjected to emulsification in the thermomixer. Thereafter the mixture was homogenized at 150/30 bar at 65-70° C. and the mixture was sterilized for example by heating to 100° C. Thereafter, the mixture was cooled to 38° C. and transglutaminase was added to the mixture. Starter culture (Streptococcus thermophilus, Lactobacillus acidophilus and Bifidobacterium animalis spp. lactis) was added. The mixture was fermented overnight at 38° C. Thereafter, the prepared curd was cut into small pieces and put into moulds with cloths. The moulds were subjected to pressing for 5 h at room temperature. The cheese was put in brine at pH 4.5. The non-dairy cheese was packed and kept refrigerated.

### Example 3b—Preparation of a Halloumi Resembling Non-Dairy Cheese Analogue Prepared with Water (without Oat-Base)

The same experimental conditions and ingredients as described in 3a were used except for omitting and replacing the oat-base with water resulting in a total amount of 766 g water.

The prepared non-dairy cheese analogues were fried in a pan. It was a clear difference in browning between the two prepared cheese analogues. The cheese analogue prepared with oat-base showed a nice browning of the surface once fried, which the cheese analogue prepared with only water did not. Thus, the oat-base as added does have a beneficial and desirable impact on the prepared cheese analogue, especially once fried.

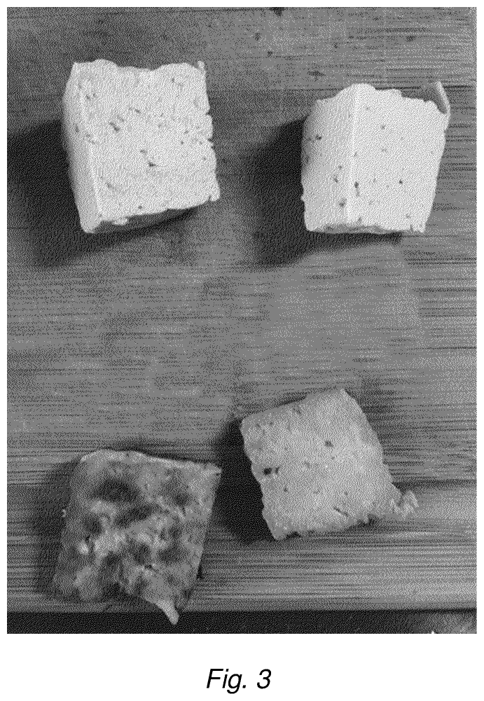

The prepared non-dairy cheese analogues are disclosed in FIG. 3.

1. A non-dairy cheese analogue comprising:
an oat derived material in an amount of 3-15% by weight of the cheese analogue;
at least one vegetable fat present in an amount of 10-25% by weight of the cheese analogue; and
at least one vegetable protein present in an amount of 10-25% by weight of the cheese analogue.

2. A non-dairy cheese analogue according to claim 1, comprising:
an oat derived material in an amount of 5-12% by weight of the cheese analogue;
at least one vegetable fat present in an amount of 17-25% by weight of the cheese analogue; and
at least one vegetable protein present in an amount of 10-17% by weight of the cheese analogue.

3. The non-dairy cheese analogue according to claim 1, further comprising calcium, preferably in form of calcium salt.

4. The non-dairy cheese analogue according to claim 1, wherein the non-dairy cheese analogue is a fermented non-dairy cheese analogue.

5. The non-dairy cheese analogue according to claim 1, wherein glutamine and lysine units of the at least one vegetable protein are cross-linked by transglutaminase.

6. A non-dairy cheese analogue according to claim 1, comprising:
an oat derived material in an amount of 5-12% by weight of the cheese analogue;
at least one vegetable fat present in an amount of 17-25% by weight of the cheese analogue;
at least one vegetable protein present in an amount of 10-17% by weight of the cheese analogue; and
wherein the non-dairy cheese analogue is fermented and comprises calcium.

7. A non-dairy cheese analogue according to claim 1, comprising:
an oat derived material in an amount of 5-12% by weight of the cheese analogue;
at least one vegetable fat present in an amount of 17-25% by weight of the cheese analogue;
at least one vegetable protein present in an amount of 10-17% by weight of the cheese analogue;
wherein the non-dairy cheese analogue is fermented, comprises calcium and wherein glutamine and lysine units of the at least one vegetable protein are cross-linked by transglutaminase.

8. The non-dairy cheese analogue according to claim 1, further comprising water in an amount of 40 to 70% by weight of the cheese analogue.

9. The non-dairy cheese analogue according to any one of the previous claims claim 1,
wherein the at least one vegetable protein is selected from a list consisting of pea protein, potato protein, faba bean protein, chickpea protein, lentil protein, mung bean, and combinations thereof, preferably the at least one vegetable protein is pea protein, and
wherein, the cheese analogue further comprises one or more additives selected from the group consisting of hydrocolloids and/or texturizers, including carrageenans, agars, pectins, xanthan, gellan gum, locust bean gum, and methyl cellulose.

10. The non-dairy cheese analogue according to claim 1, wherein the vegetable fat comprises 45-75% of saturated fat, 20-34% of monounsaturated fat, and 5-19% of polyunsaturated fat, by weight of the vegetable fat.

11. The non-dairy cheese analogue according to claim 1, wherein the vegetable fat is selected from the group consisting of rapeseed oil, sunflower oil, coconut oil, corn oil, and a combination thereof.

12. The non-dairy cheese analogue according to claim 1, wherein the oat derived material is obtained from treatment of oats with suitable enzymes for degradation or breakdown of starch present in the oats.

13. A method for manufacturing of non-dairy cheese analogue, the method comprising:
providing a mixture comprising oat derived material, at least one vegetable fat, and at least one vegetable protein,
adding fermenting culture and, further adding transglutaminase to the mixture,
fermenting the mixture, resulting in formation of a curd.

14. The method for manufacturing of non-dairy cheese analogue according to claim 13, the method further comprising, prior to the adding fermenting culture:
heat treating the mixture to above 38° C., followed by cooling the mixture to below 38° C.

15. The method for manufacturing of non-dairy cheese analogue according to claim 13, wherein the providing a mixture comprises:
mixing the oat derived material and water,
adding dry ingredients comprising vegetable protein under heating between 50° ° C. and 70° C., and thereafter the vegetable fat in liquid form,
homogenizing, thereby providing the mixture comprising oat derived material, vegetable fat, and at least one vegetable protein.

16. The method for manufacturing of non-dairy cheese analogue according to claim 13, comprising subjecting the curd to treatment for removal of water, followed by soaking in brine the curd obtained after removal of water.

17. The method for manufacturing of non-dairy cheese analogue according to claim 13, wherein the providing a mixture comprises:
mixing the oat derived material and water, thereby obtaining a mixture,
heating the mixture to a temperature between 50° C. and 90° C.,
adding dry ingredients comprising vegetable protein under continued heating between 50° C. and 90° C., and thereafter adding the vegetable fat in liquid form,
emulsifying, thereby providing the mixture comprising oat derived material, vegetable fat, and at least one vegetable protein.

18. The method for manufacturing of non-dairy cheese analogue according to claim 13, wherein transglutaminase is added before, during, and/or after the fermentation.

19. The method for manufacturing of non-dairy cheese analogue according to claim 13, wherein the amount of the oat-derived material is 3-15% by weight of the mixture, the amount of the at least one vegetable protein is 5-25% by weight of the mixture, and the amount at the least one vegetable fat is 5-25% by weight of the mixture.

20. The method according to claim 13 for manufacturing a non-dairy cheese analogue, the non-dairy cheese analogue comprising:
an oat derived material in an amount of 3-15% by weight of the cheese analogue;
at least one vegetable fat present in an amount of 10-25% by weight of the cheese analogue; and
at least one vegetable protein present in an amount of 10-25% by weight of the cheese analogue.

21. A non-dairy cheese analogue obtainable by the method according to claim 13.
